(19) United States
(12) Patent Application Publication
(10) Pub. No.: US 2022/0215833 A1
(43) Pub. Date: Jul. 7, 2022

(54) METHOD AND DEVICE FOR CONVERTING SPOKEN WORDS TO TEXT FORM

(71) Applicant: Lenovo (Singapore) Pte. Ltd., New Tech Park (SG)

(72) Inventors: Mark Patrick Delaney, Raleigh, NC (US); John Carl Mese, Cary, NC (US); Nathan J. Peterson, Oxford, NC (US); Arnold S. Weksler, Raleigh, NC (US); Russell Speight VanBlon, Raleigh, NC (US)

(21) Appl. No.: 17/143,913

(22) Filed: Jan. 7, 2021

(51) Int. Cl. G10L 15/183; G10L 25/78; G06F 40/20

(52) U.S. Cl. CPC G10L 15/183; G06F 40/20; G10L 25/78

(57) ABSTRACT

An electronic device is provided that includes a processor, and a data storage device having executable instructions accessible by the processor. Responsive to execution of the instructions, the processor obtains primary context data, and obtains secondary context data from a secondary electronic device. The processor also analyzes the primary context data and the secondary context data utilizing an electronic device context (EDC) model to determine a context of a spoken word, and converts the spoken word into a text form based on the context of the spoken word.

### BACKGROUND

Embodiments herein generally relate to methods and devices for converting spoken words into text form.

Electronic devices have become essential to everyday life in many ways. Access to electronic devices can benefit people in various ways, such as providing better communication, information for work and school, and entertainment. In addition, electronic devices have become a main medium for communication. Instead of picking up a phone and calling an individual at a number at a time that may not be convenient for the individual, an individual can easily text the individual. This allows the text message to be opened when the individual has time to read the message, and respond when convenient. To this end, text messages have become a form of communication that allows groups of individuals to be on a text or group chat together. This allows friends or individuals that have common interests, such as a favorite sports team, to watch a game at the same time together and send text messages to one another in real time about the event. Similarly, other events, such as Presidential debates, newsworthy events, etc. can all be texted about with individuals with the text chat group.

As texting based communication continues to grow, voice to text mode communication is becoming more and more common as natural language understanding (NLU) models become better and quicker. Many users find voice to text mode quicker than texting physically with their fingers. However, voice to text mode is reliant on the quality of the voice input to deduce a text output. In particular, many words exist in language that are exceptionally similar to one another in sound. Whether rhyming words, homonyms, two or more words that sound like one word, one word that sounds like two or more words, or the like, inaccuracies in converting spoken words into text form is all too common. In addition, when a word is not understood, autocorrect can result in completely unintended messages being sent, leading to confusion, and embarrassment.

As a result, when using voice to text mode technology, individuals either need to review the message before sending, and correct any errors within the message, or risk sending a non-sensical or unintended communication. When correcting, the time to delete and fix the communication can result in completely taking away the advantage of the time savings of using the voice to text mode in the first place, leading to annoyance experienced by the user.

### SUMMARY

In accordance with embodiments herein, an electronic device is provided that includes a processor, and a data storage device having executable instructions accessible by the processor. Responsive to execution of the instructions, the processor obtains primary context data, and obtains secondary context data from a secondary electronic device. The processor also analyzes the primary context data and the secondary context data utilizing a electronic device context (EDC) model to determine a context of a spoken word, and converts the spoken word into a text form based on the context of the spoken word.

Optionally, the operating step of analyzing the primary context data and the secondary context data utilizing the EDC model to determine the context of the spoken word comprises applying a natural language understanding (NLU) model. In one example, the NLU model and EDC model separately, or in combination, determine the context of the spoken word. In one aspect, the primary context data is obtained from the data storage device.

Optionally, the electronic device also includes at least one sensor, and the primary context data is obtained from the at least one sensor. In one example, the at least one sensor includes one of image recognition software, gesture recognition software, voice recognition software, or global positioning system (GPS) software. In one aspect, the secondary electronic device is one of a smart phone, a smart watch, a smart TVs, a tablet device, a personal digital assistant (PDAs), a voice-controlled intelligent personal assistant service device, or a smart speaker.

In accordance with embodiments herein a method is provided. Specifically, under the control of one or more processors including program instructions to obtain primary context data from a primary electronic device, and obtain secondary context data from a secondary electronic device. The method also includes analyzing the primary context data and the secondary context data utilizing a electronic device context (EDC) model to determine a context of a spoken word, and converting the spoken word into a text form based on the context of the spoken word.

Optionally, to analyze the primary context data and the secondary context data utilizing a electronic device context model to determine the context of the spoken word comprises applying a natural language understanding (NLU) model. In one example, the NLU model and EDC model separately, or in combination, determine the context of the spoken word. In one aspect, to obtain the primary context data includes accessing a data storage device of the primary electronic device. In another example, to obtain the primary context data includes detecting, with a sensor, the primary context data. In another aspect, to obtain the secondary context data includes automatically wirelessly communicating the secondary context data from the secondary electronic device to the primary electronic device. In another embodiment, the one or more processors also include program instructions to, obtain auxiliary secondary context data from an auxiliary secondary electronic device, and analyze the primary context data, the secondary context data, and auxiliary secondary context data utilizing the EDC model to determine the context of the spoken word. In one aspect, to convert the spoken word into a text form based on the context of the spoken word includes determining, with the one or more processors, a candidate text form, and modifying the candidate text form to the text form based on the context of the spoken word determined. Alternatively, the candidate text form is determined by a natural language understanding model, and the candidate text form is modified by the EDC model.

In accordance with embodiments herein, a computer program product is provided. The computer program product includes a non-signal computer readable storage medium that has computer executable code to convert a spoken word into text by automatically detecting a spoken word, and obtaining primary context data from a primary electronic device. The executable code also is provided for receiving, at the primary electronic device, secondary context data from one or more secondary electronic devices, and analyzing the primary context data and the secondary context data utilizing a electronic device context (EDC) model to determine a context of the spoken words. Executable code is also provided for choosing between two or more candidate text forms based on the context of the spoken words determined when converting the spoken word into a text form.

Optionally, the computer executable code is also provided for utilizing the electronic device context model to determine at least one of: a subject related to a program displayed by the secondary electronic device, a presence of two or more individuals, or a meeting or an event scheduled in a calendar of a secondary electronic device. In one aspect, computer executable code is also provided for identifying individuals in an environment, and utilizing the identification of the individuals as one of the primary context data or the secondary context data. In one example, the computer executable code is provided for modifying a natural language understanding (NLU) model based on the context of the spoken word determined.

### BRIEF DESCRIPTION OF THE DRAWINGS

FIG. 1 illustrates a system for converting spoken words into text form in accordance with embodiments herein.

FIG. 2 illustrates a process for converting spoken word into text form in accordance with embodiments herein.

FIG. 3 illustrates a process for analyzing context data to determine a context of a spoken word in accordance with embodiments herein.

FIG. 4 illustrates a process for analyzing context data to determine a context of a spoken word in accordance with embodiments herein.

FIG. 5 illustrates a block diagram of a system for supporting management of secondary electronic devices by one or more primary electronic devices in accordance with embodiments herein.

FIG. 6 illustrates a block diagram of a primary electronic device in accordance with embodiment herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The terms “electronic device context model” and “EDC model” shall mean advanced models and/or algorithms, including machine learning models or algorithms, that utilize a NLU model, and context data to identify context of spoken words. The context data can be received from a primary electronic device or secondary electronic devices including from sensors that utilize image recognition software, gesture recognition software, voice recognition software, global positioning system (GPS) software, and the like. The EDC model determines the context of spoken words of an individual based on analysis of the content data obtained from a primary electronic device and/or context data obtained from a secondary electronic device. The NLU model in combination with the EDC model is utilized to perform the conversion of the spoken words into text form. At least some NLU model architectures utilize a lexicon of one or more languages, a text parser, grandma rules, semantic theories, and logical inferences to break sentences and phrases into internal representations and formal meaning representations. The NLU model and EDC model may be utilized independently, or in combination to convert spoken words to text form from the corresponding context data.

The term “primary electronic device” shall mean any device, system, controller, etc. that may monitor and communicate data and information that is related to an individual. Primary electronic devices can include smart phones, smart watches, smart remotes, etc. that can convert an individual's words and statements into text form. The primary electronic device can covert the words and statements into text form utilizing a NLU model, an autocorrect model, other spoken words to text form models, etc. The primary electronic device is also configured to communicate with secondary electronic devices to receive data and information related to the individual and can be utilized within an EDC model. The primary electronic device may communicate with one or more secondary electronic devices over a wire, through one or more wireless protocols including Bluetooth, GSM, infrared wireless LAN, HIPERLAN, 4G, 5G, satellite, or the like.

The term “secondary electronic device” shall mean any device, system, controller, etc. that may monitor and communicate data and information that is related to an individual that is not a primary electronic device, and does not convert words or statements into text. For clarification, a secondary electronic device can be configured to convert words and statements into text; however, when utilized in association with the primary electronic device, the secondary electronic device is only utilized to obtain information and data that may be utilized within the EDC model. In particular, the primary electronic device utilizes the EDC model to convert words and statements into text, whereas the secondary electronic devices only provide information and data that is utilized within the EDC model. Secondary electronic devices include Internet of Things (IoT) devices, smart phones, smart watches, smart TVs, tablet devices, personal digital assistants (PDAs), voice-controlled intelligent personal assistant service devices including Alexa®, Google Home®, or the like, smart speakers, etc.

The term “context” shall mean any and all nomenclature, words, phrases, etc. related to spoken words based on context data obtained from an environment. The context data can be obtained from sensors of a primary electronic device, sensors of a secondary electronic device, a storage device of a primary electronic device or secondary electronic device, a determination made from information communicated from a secondary electronic device to a primary electronic device, a determination made from data detected by a primary electronic device or secondary electronic device, data detected by a primary electronic device or secondary electronic device, or the like. The context data can include individual identifications, the number of individuals in an environment, motion data, information and data related to events such as sporting events, concerts, plays, or the like, being observed by an individual, etc. The context includes nomenclature, words, phrases, etc. that may be researched, determined, and or obtained from context data, or from analyzing context data.

The phrase “text form” shall mean any and all words or phrases within a text message. The text message can be sent to one individual, or a text group, or chat. A single word of a text message may be considered a text form, or the entire message may be considered a text form. Words in an email message are not considered text form, because an email is not considered a text message, and instead is an electronic message. A text message, however, is considered an electronic message. A computer platform, such as Word is also not considered a text message and instead is considered a document.

The term “obtains” and “obtaining”, as used in connection with data, signals, information and the like, include at least one of i) accessing memory of an external device or remote server where the data, signals, information, etc. are stored, ii) receiving the data, signals, information, etc. over a wireless communications link between the primary electronic device and a secondary electronic device, and/or iii) receiving the data, signals, information, etc. at a remote server over a network connection. The obtaining operation, when from the perspective of a primary electronic device, may include sensing new signals in real time, and/or accessing memory to read stored data, signals, information, etc. from memory within the primary electronic device. The obtaining operation, when from the perspective of a secondary electronic device, includes receiving the data, signals, information, etc. at a transceiver of the secondary electronic device where the data, signals, information, etc. are transmitted from a primary electronic device and/or a remote server. The obtaining operation may be from the perspective of a remote server, such as when receiving the data, signals, information, etc. at a network interface from a local external device and/or directly from a primary electronic device. The remote server may also obtain the data, signals, information, etc. from local memory and/or from other memory, such as within a cloud storage environment and/or from the memory of a personal computer.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

A system and processes are provided for strengthening a voice to text mode model such as a NLU model, or autocorrect model, through context data received from surrounding IoT devices. When an individual with a primary electronic device such as a cell phone actuates a voice to text mode, the primary electronic device obtains context data from the primary electronic device, and secondary electronic devices to provide for utilization in an EDC model to convert the spoken words of the individual into text form. Such context data can include image data obtained by a sensor utilizing image recognition software, location information obtained from a global positioning system (GPS) in a primary or secondary electronic device, conversation history within a chat text, etc. By using the context data in association with the EDC model, accuracy of the conversion of the spoken words to a text form is accomplished.

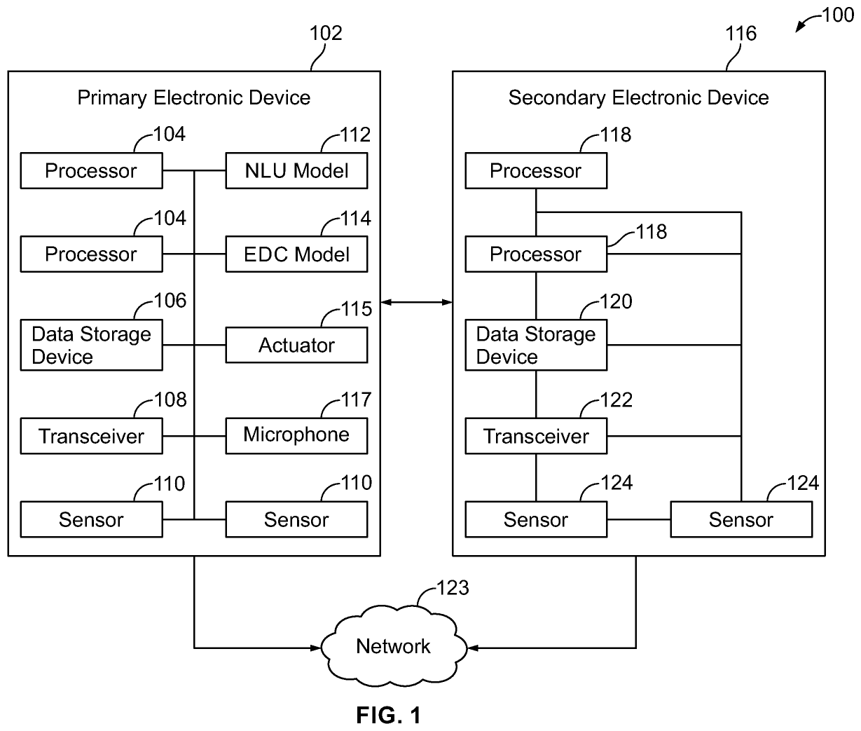

FIG. 1 provides an illustration of a system 100 to implement and/or convert spoken words into text form in accordance with embodiments herein. The system 100 includes a primary electronic device 102 that is an electronic device. The primary electronic device 102 can be a smart phone, a smart watch, a tablet device, a personal digital assistant (PDAs), a voice-controlled intelligent personal assistant service device including Alexa®, Siri®, Google Home®, or the like, a smart speaker, other IoT devices, or the like. The primary electronic device 102 includes one or more processors 104, a data storage device 106, or memory, and a transceiver 108. The transceiver 108 in one embodiment may be a separate receiver and transmitter, while alternatively the transceiver may be a single component. The primary electronic device 102 may optionally include and one or more sensors 110 for detecting context data.

The one or more sensors 110 can be motion sensors, sound sensors, facial recognition sensors, and/or the sensors 110 can include image recognition software, gesture recognition software, voice recognition software, global positioning system (GPS) software, or the like. In particular, the one or more sensors are configured to detect context data in an environment. In one example, the presence of individuals in an environment, is the context data. In another example, information that is utilized to identify an individual in an environment, whether through facial recognition, voice detection, movements, or the like. For example, facial recognition and voice detection can be utilized to identify a specific person in an environment. Alternatively, if a baby is crawling on the floor, a motion detector that senses the crawling movement may be utilized to identify the baby in the environment. Similarly, movement of a pet may also be utilized to identify the animal in the environment. In each instance, the sensor is utilized to obtain primary context data.

The primary electronic device 102 also includes a NLU model 112, and an EDC model 114. The NLU model 112 functions to convert spoken words into text form, while the EDC model determines the context of the spoken words when converting a spoken word into text form. In one embodiment, the NIX model and EDC model separately determine a context of the spoken word. Specifically, when a person dictates a text message, the person may state, “Doug just arrived to watch the game.” In one embodiment, the NLU determines that the text form is “Hug just arrived to watch the game.” The EDC model then takes the statement “1-lug just arrived to watch the game” and from primary context data in the form of voice recognition of Doug in the environment, modifies the text form to state “Doug just arrived to watch the game.”

Alternatively, in another embodiment, the NUJ determines candidate text forms that include “Doug just arrived to watch the game”, “hug just arrived to watch the game”, and “dug just arrived to watch the game”. Then, from primary context data in the data storage device of a calendar that indicates “watching game with Doug, Andy and John” scheduled for the current time, the EDC model chooses “Doug just arrive to watch the game.” In yet another embodiment, the EDC model and NLU determine the context of the spoken word together. Specifically, in such embodiments, the NLU model is modified by the EDC model to take under consideration the context of the spoken word. In this manner, the text form is selected by the NLU utilizing the EDC model, instead of determining the text form, and then modifying the text form based on the EDC model.

Optionally, the primary electronic device 102 also includes an actuator 115 for activating a voice to text mode. The actuator 115 causes a microphone 117 of the primary electronic device to begin detecting sounds for spoken words. The primary electronic device than converts the spoken words into text form, include through utilizing the NLU model and EDC model. In one example, the actuator 115 is an actuation button on the primary electronic device, that when compressed, activates the voice to text mode and converts spoken words detected by the microphone into text form. When not compressed, the microphone 117 detecting sounds such that the primary electronic device 102 does not convert spoken words into text form. Alternatively, the actuator 115 is a touch screen that allows a user to place the primary electronic device in a spoken words to text form mode, such that primary electronic device 102 is voice activated, and the primary electronic device 102 begins recording and converting spoken words into text form upon detecting sound. In this manner, a push button that must be held down for activation is unnecessary.

The system 100 also includes one or more secondary electronic devices 116 that communicate secondary context data to the primary electronic device 102. Secondary electronic devices 116 can include smart phones, smart watches, smart TVs, tablet devices, laptop computers, personal digital assistants (PDAs), voice-controlled intelligent personal assistant service devices including Alexa®, Siri®, Google Home®, or the like, smart speakers, other IoT devices, etc. Each secondary electronic device 116 can include one or more processors 118, a data storage device 120 or memory, and a transceiver 122 for communicating with the transceiver 108 of the primary electronic device 102. The transceiver 122 in one embodiment may be a separate receiver and transmitter, while alternatively the transceiver may be a single component. To this end, the primary electronic device 102 may communicate with one or more secondary electronic devices 116 over a network 123, including by utilizing a wire, through one or more wireless protocols including Bluetooth, GSM, infrared wireless LAN, HIPERLAN, 4G, 5G, satellite, or the like. The secondary electronic devices 116 may also optionally include one or more sensors 124 for detecting secondary context data in a similar manner as the one or more sensors 110 of the primary electronic device are utilized to detect secondary context data. The one or more sensors 124 can be motion sensors, sound sensors, facial recognition sensors, and/or the sensors 124 can include image recognition software, gesture recognition software, voice recognition software, global positioning system (GPS) software, or the like. In particular, the one or more sensors 124 are configured to detect context data in an environment.

The secondary electronic devices 116 may be utilized to provide secondary context data to the primary electronic device 102 for use with the NLU model 112 and EDC model 114. Upon actuation by voice conversion actuator 115, or otherwise, the primary electronic device 102 automatically begins monitoring and communicating with all active secondary electronic devices 116 in a threshold radius. In one embodiment, the threshold radius is ten (10 ft). In another embodiment, the threshold radius is one hundred (100) ft. In yet another embodiment, the primary electronic device 102 automatically begins monitoring and communicating with all active secondary electronic devices 116 until at least a threshold number of secondary electronic devices are detected. In one example, three (3) secondary electronic devices are detected. Alternatively, the secondary electronic devices 116 continuously monitors for a primary electronic device 102, and upon detection of the primary electronic device 102, begins communicating secondary context data to the primary electronic device 102. In such an example, actuation of the primary electronic device 112 by the voice conversion actuator 115, or otherwise, results in utilizing the secondary context data communicated by the secondary electronic device 116. Based on the secondary context data, the NLU model 112 and EDC model 114 determine the text form based on the spoken words.

In one example, a secondary electronic device 116 is a smart TV while the primary electronic device 102 is a mobile phone. An individual watching NASCAR on the smart TV may desire to text his brother about the race to state “[T]he driver needs a good pit stop.” When converting the stated “the driver needs a good pit stop” into text form, the primary electronic device 102 communicates with the secondary source 116 (e.g. the smart TV) to obtain secondary context data (e.g. that NASCAR racing is being watched by the individual). Based on the secondary context data that NASCAR racing is being watched by the individual, common nomenclature associated with racing is reviewed. In this manner, instead of converting the spoken words to be “the driver needs a good pet shop”, the primary electronic device 102 determines that the user states “the driver needs a good pit stop”.

In another example, an individual may be listing to music on a secondary electronic device such as a smart speaker. When a Frank Sinatra song comes on the radio, the individual may active their primary electronic device, a cell phone to text another that “I am listening to Ole Blue Eyes”. In this example, when only utilizing a NLU model, the conversion from spoken words to text form could provide “I am listening to old blue guys”. Instead, the smart speaker communicates context data related to the song being played by the smart speaker. The context data can be the name of the song, the name of the group or singer performing the song, the year the song was released, the album the song was release on, etc. Based on this communicated information, the EDC model obtains data associated with the context data, such as nomenclature associated with the song, singer, band, year, etc. In the example, the nomenclature would include “Ole Blue Eyes” as a nickname for Frank Sinatra. In this manner, the EDC model would determine, or modify the determination of a NLU model to provide the text form as “Ole Blue Eyes”.

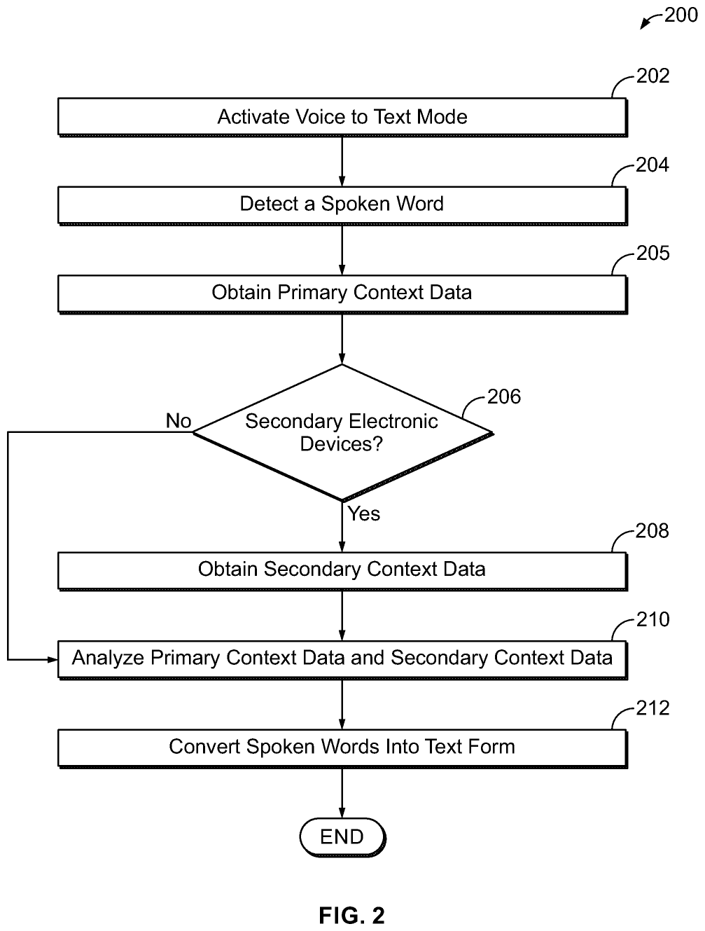

FIG. 2 illustrates a process 200 for converting spoken words into text form in accordance with embodiments herein. In one example, the system of FIG. 1 is utilized to perform the process.

At 202, one or more processors activate a voice to text mode of a primary electronic device. The voice to text mode results in the primary electronic device detecting spoken words so that the spoken words may be converted into a text form. In one example, a touch screen or manual input keys may be utilized to place the primary electronic device into the active setting. Alternatively, an actuator, such as a push button actuator is compressed, and while the push button is compressed, the voice to text mode is active. Once the push button actuator is no longer compressed, the voice to text mode is no longer active. In other examples, a sliding actuator, or other mechanical actuator may be provided. Additionally, the voice to text mode may be active during actuation of the actuator, for a determined period after initial actuation of the actuator, during actuation of the actuator plus an additional determined period after initial actuation, or the like. Alternatively, the voice to text mode may be activated by voice activation, where a certain known phrase such as “hey google, voice to text mode” results in activation. Alternatively, activation may be time related where a timer is utilized such that voice to text mode occurs during a certain period of each day.

At 204, one or more processors detect a spoken word. After the voice to text mode is activated a microphone of the primary electronic device begins detecting and recording sounds in order to detect spoken words.

At 205, one or more processors obtain primary context data from the primary electronic device. Primary context data includes any data or information that may relate to the spoken words being detected. In one example, the primary context data may be obtained by utilizing one or more sensors. In one embodiment, the one or more sensors may include a GPS sensor that determines the location of the primary electronic device. So, if the primary electronic device is a cellular phone being utilized by someone at a park while their child plays on playground equipment, the GPS can identify the primary electronic device as at a park. Alternatively, the one or more sensors may be a voice recognition sensor. For example, the primary electronic device is a voice-controlled intelligent personal assistant service device that is programed to recognize different voices for permission reasons, and an individual wants the the voice-controlled intelligent personal assist service device to send a text. Voices of other family members in the room may be determined by the voice-controlled intelligent personal assist service device accordingly. In other examples, the primary context data is not obtained by sensors. For example, if a photo is being attached to the text message, image recognition software may be utilized to determine people, places, animals, landmarks, etc. in the image that may be related to the text message. In another example, software may identify a meme or video clip attached to a text message information about a movie, TV show, celebrity, video clip, etc. In yet another example, information stored in a data storage device or memory of the primary electronic device may be utilized as primary context data. Such primary context data includes previous text messages with the individual who is being texting with, recent purchases made using the primary electronic device, recent webpages viewed on the primary electronic device, common webpages viewed on the primary electronic device, recent food orders made from the primary electronic device, recent applications or games used or played on the primary electronic device, or the like. In yet another example, a calendar on the primary electronic device may be accessed with appointment information obtained as primary context data.

At 206, one or more processors determine if secondary electronic devices are within an environment. In one example, Upon activation of the voice to text mode, the primary electronic device searches for secondary electronic devices within a network within an environment that are able to communicate with the primary electronic device. An environment is considered any area, space, dwelling, vehicle, building, outdoor area, etc. where the primary electronic device is in close proximity to a secondary electronic device. In one embodiment, an environment can be a determined distance from the primary electronic device, such as a 30 foot radius, a 60 foot radius, a 1 mile radius, a 5 mile radius, etc. Alternatively, an environment can be a specific structure such as a home, office building, church, school, etc. In other examples, the environment can be a room, cubical, floor, etc. In yet another embodiment, the environment may include all secondary electronic devices coupled to a common network or server. Meanwhile, the primary electronic device and secondary electronic device may communicate through the network over a wire, through one or more wireless protocols including Bluetooth, GSM, infrared wireless LAN, HIPERLAN, 4G, 5G, satellite, or the like.

Alternatively, the primary electronic device continuously searches for secondary electronic devices in a given environment, and upon discovering a secondary electronic device the primary electronic device is in continuous communication with such secondary electronic devices in a given environment. By continuously communicating with secondary electronic devices, the primary electronic device can receive data and information from about a given environment.

If at 206, at least one secondary electronic device is determined to be within the environment, at 208, the one or more processors obtain secondary context data from the secondary electronic device. Upon determining that a secondary electronic device is available, the secondary electronic device beings communicating secondary context data with the primary electronic device. As described above, the secondary context data can include person identification based data, television show based data, event based data, personal based data, song based data etc. In an embodiment when more than one secondary electronic device is available, each secondary electronic device communicates with the primary electronic device to provide data. In this manner, one secondary electronic device provides secondary electronic device data while an auxiliary secondary electronic device provides auxiliary secondary electronic device data. In all, each secondary electronic device provides its own unique secondary electronic device data. In one example, one secondary electronic device can be a smart TV that has a baseball game playing, and provides secondary electronic device data related to the teams playing, the players playing, the stadium where the game is being played, etc. Meanwhile, an auxiliary secondary electronic device can be a PDA of an individual watching the game that includes auxiliary secondary electronic device data of a family calendar indicating “game at Rick's house” from 7:00-10:00 in a family calendar. Thus, if at 8:00 an individual with a primary electronic device activates a voice to text mode and states “At Rick's watching the Sox”, secondary electronic device data, including the auxiliary secondary electronic device data can be utilized to prevent the conversion to “At rips washing the socks”, or another incorrect variation.

After obtaining the secondary context data at 208, or if at 206, a determination is made that no secondary electronic device can be identified and communicated with in the environment, and 208 is by-passed, at 210 the one or more processors analyze the primary context data and the secondary context data (if any) utilizing a EDC context model to determine a context of the spoken word. In the example where friends are getting together to watch the game, the primary context data may include text messages from the previous couple of days related to meeting at Rick's house to watch the White Sox play at 7:00, or recent views of webpages related to the White Sox. In an embodiment where the TV is not a smart TV and no secondary electronic devices can be located, the EDC context model only uses this primary context data to determine the context of the spoken words. Consequently, the information of being at Rick's house, the White Sox playing, the time of the game in close proximity to the game facilitate the EDC context model correctly converting the spoken words into text form. When the secondary context data and auxiliary secondary context data is included, multiple uses of the terms “Rick” and “Sox” and then presented, and provides verification the game is ongoing. Therefore, a more accurate determination can be achieved when determining the context of the spoken words.

At 212, the one or more processors convert spoken words into a text form based on the context of the spoken word. After the EDC context model determines the context, the spoken words detected by the primary electronic device are converted into text form. By utilizing the EDC context model, a practical result of more accurate conversion of spoken words to text form is achieved, improving communication between individuals, and saving time associated with correcting text messages.

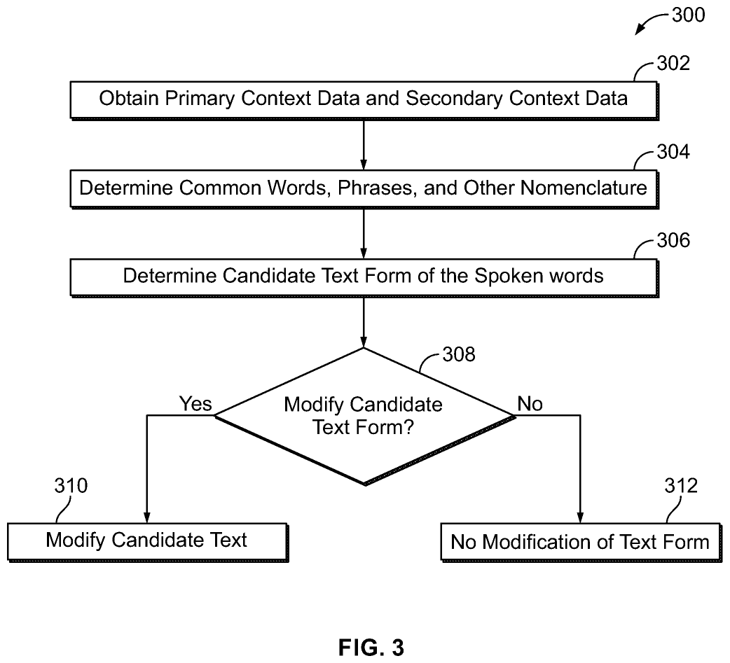

FIG. 3 illustrates a process 300 of analyzing context data to determine a context of a spoken word and utilizing the context to convert the spoken word into text form. In one example, the system of FIG. 1 is utilized to perform the process. In one embodiment, the process of FIG. 3 is utilized by one or more processors to accomplish steps 210 and 212 of FIG. 2.

At 302, one or more processors obtain primary context data, and secondary context data. The primary context data, and secondary context data in one example are obtained as described in relation to FIG. 2.

At 304, the one or more processors determine common words, phrases, and other nomenclature associated with the primary context data and secondary context data. For example, if a work meeting is occurring to review cybersecurity protocols and employee requirements, the primary context data and/or secondary context data may include a work calendar appointment named cybersecurity, an attachment to an email entitled cybersecurity meeting of a PowerPoint presentation called “cybersecurity”, facial recognition identifying the head of IT at the meeting, etc. From this primary context data and secondary context data, the EDC model determines common cybersecurity terms and phrases, and common IT terms and phrases. In one example, an internet based search is provided for the term cybersecurity, and the most common words and phrases in those webpages may be utilized as the context of common words and phrases. Alternatively, the PowerPoint attachment can by analyzed for common words and phrases to provide the context. In yet another example, a database with common words and phrases associated with certain terms may be within a data storage device of the primary electronic device, and is accessible over a network to the primary electronic device. In each instance, common words and phrases are the context determined by the EDC model.

At 306, one or more processors utilize a NLU model to determine a candidate text form of the spoken words. The candidate text form is the text form that the NLU determines was stated by an individual. For example, in the NASCAR example, the phrase “the driver needs a good pet shop” would be the candidate text form.

At 308, one or more processors determine if the candidate text form should be modified utilizing the EDC model. In particular, the EDC determines a list of words related to each word of the candidate text form that are similar to the spoken words. For example, words that rhyme, homonyms, similar sounding words, etc. may be determined. Then words and phrases in the context data, or related to the context data, are compared to the words related to the candidate text form. When a match is provided, or when a mathematical function or model is presented that indicates the probability the word or phrase should be the one related to the context data, then at 310 the candidate text form is modified. In this manner, the context data is utilized to provide autocorrect functionality. If at 308, the one or more processors determine a match is not provided, or that the probability a word or phrase related to the context data is not more likely the spoken word or phrase of the candidate text form, then at 312, no modification to the candidate text form is provided.

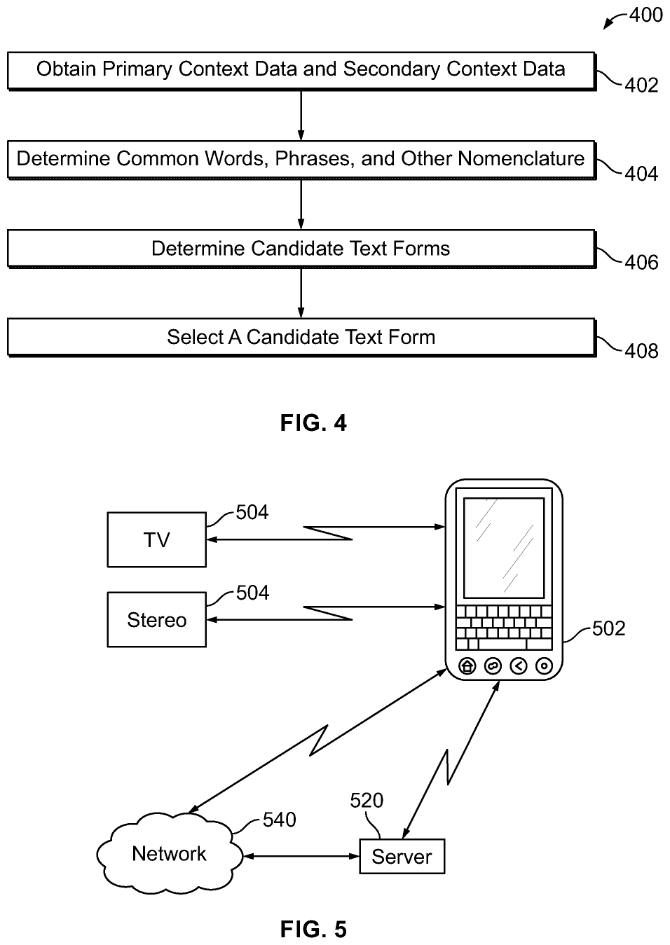

FIG. 4 illustrates an alternative process 400 of analyzing context data to determine a context of a spoken word and utilizing the context to convert the spoken word into text form. In one example, the system of FIG. 1 is utilized to perform the process. In one embodiment, the process of FIG. 4 is utilized by one or more processors to accomplish steps 210 and 212 of FIG. 2.

At 402, one or more processors obtain primary context data, and secondary context data. The primary context data, and secondary context data in one example are obtain as described in relation to FIG. 2.

At 404, the one or more processors determine common words, phrases, and other nomenclature associated with the primary context data and secondary context data. The one or more processors determine the common words, phrases, and other nomenclature associated with the primary context data and secondary context data in the same manner as described in relation to step 304 of the process of FIG. 3.

At 406, one or more processors utilize a NLU model to determine numerous candidate text forms of spoken words. Candidate text forms include potential text forms that could be selected by the one or more processors when converting spoken words into the text form. For example, in the NASCAR example, the phrase “the driver needs a good pet shop” would be a first candidate text form, while “the driver needs a good pit stop” is a second candidate text form, and “the driver needs a good sit pop” is a third candidate text form. Additional candidate text forms may also be determined.

At 408, one or more processors utilize an EDC model to select the candidate text form of the spoken words for presentation. In particular, based on the context data, terms related to NASCAR are obtained. Such words may include race, racetrack, pit stop, driver's names, track names, changing tires, chassis, restrictor plate, wreck, racecar numbers, etc. Based on these terms, the candidate text form “the driver needs a good pit stop” is selected. In another example, five or more candidate text forms are provided, and the one or more processors select the candidate text form with terms that are related to NASCAR. While in this example, NASCAR related terms are obtained, in other embodiments the EDC model obtains terms related a subject related to a program displayed by a secondary electronic device, names or information related to two or more individuals, terms related to a meeting, people attending the meeting, the subject of the meeting, etc.

FIG. 5 is a block diagram of a system for supporting management of secondary electronic devices by one or more primary electronic devices in accordance with embodiments herein. The system includes a primary electronic device 502, one or more secondary electronic devices 504, one or more servers 520. By way of example, the primary electronic device 502 may be a mobile device, such as a cellular telephone, smartphone, tablet computer, personal digital assistant, laptop/desktop computer, gaming system, a media streaming hub device, IoT device, or other electronic terminal that includes a user interface and is configured to access a network 540 over a wired or wireless connection. As non-limiting examples, the primary electronic device 502 may access the network 540 through a wireless communications channel and/or through a network connection (e.g. the Internet). Optionally, the primary electronic device 502 may be responsive to voice commands. Additionally or alternatively, the primary electronic device 502 may be a wired or wireless communication terminal, such as a desktop computer, laptop computer, network-ready television, set-top box, and the like. The primary electronic device 502 may be configured to access the network using a web browser or a native application executing thereon. In some embodiments, the primary electronic device 502 may have a physical size or form factor that enables it to be easily carried or transported by a user, or the primary electronic device 502 may have a larger physical size or form factor than a mobile device.

The secondary electronic device 504 may represent the same or different type of device as the primary electronic device 502, such as a tablet computer, mobile phone, personal digital assistant, laptop/desktop computer and the like. In addition, other non-limiting examples of secondary electronic devices 504 include televisions, stereos, home appliances, network devices (e.g. routers, hubs, etc.), remote-controlled electronic devices, a wearable device such as a smart watch or smart glasses, home automation electronic hubs (e.g. the Amazon Echo device), content management and streaming devices (e.g. the Chrome Cast device, Roku device, Kire TV stick device, Sonos devices), video games, cameras, camcorders, drones, toys, home theater systems, automobiles, GPS systems, audio content players and the like.

The primary electronic device 502 (and optionally the secondary electronic devices 504) are configured to communication over the network 540 with various types of network electronic devices. The primary electronic device 502 is configured to access network electronic devices 550, including web-based or network-based data, applications, and services, via the network 540. The network 540 may represent one or more of a local area network (LAN), a wide area network (WAN), an Intranet or other private network that may not be accessible by the general public, or a global network, such as the Internet or other publicly accessible network.

In the example of FIG. 5, the primary electronic device 502 represents a cellular telephone that communicates with a cellular network 504 over one or more communications channels 542. The communication between the primary electronic device 502 and the cellular network may be unidirectional or bidirectional. A communications channel 542 may be provided by any communications provider, such as any source that disseminates information. The network 540 and communications channel 542 may be physically/logically separate channels. Optionally, the network 540 and communications channel 542 may be separate channels over the same underlying network.

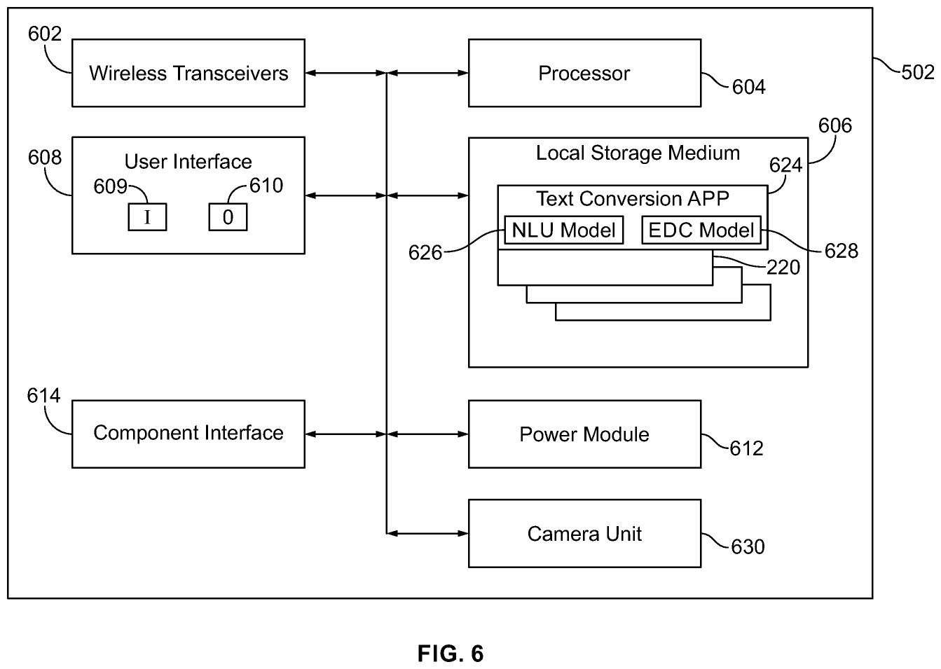

FIG. 6 illustrates a simplified block diagram of the primary electronic device 502 of FIG. 5 in accordance with an embodiment. The primary electronic device 502 includes components such as one or more wireless transceivers 602, one or more processors 604 (e.g., a microprocessor, microcomputer, application-specific integrated circuit, etc.), one or more local storage medium (also referred to as a memory portion) 606, a user interface 608 which includes one or more input devices 609 and one or more output devices 610, a power module 612, a component interface 614 and a camera unit 630. All of these components can be operatively coupled to one another, and can be in communication with one another, by way of one or more internal communication links, such as an internal bus. The camera unit 630 may capture one or more frames of image data.

The input and output devices 609, 610 may each include a variety of visual, audio, and/or mechanical devices. For example, the input devices 609 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 610 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 610 may include a touch sensitive screen, a non-touch sensitive screen, a text-only display, a smart phone display, an audio output (e.g., a speaker or headphone jack), and/or any combination thereof.

The user interface 608 permits the user to select one or more of a switch, button or icon to collect context data, and/or enter context data. The user interface 608 can also direct the camera unit 630 to take a photo or video (e.g., capture image data). As another example, the user may select a context data collection button on the user interface 608 two or more successive times, thereby instructing the primary electronic device 602 to capture the context data.

As another example, the user may enter one or more predefined touch gestures and/or voice command through a microphone on the primary electronic device 502. The predefined touch gestures and/or voice command may instruct the primary electronic device 502 to obtain context data, or activate obtaining context data.

The local storage medium 606 can encompass one or more memory devices of any of a variety of forms (e.g., read only memory, random access memory, static random access memory, dynamic random access memory, etc.) and can be used by the processor 604 to store and retrieve data. The data that is stored by the local storage medium 606 can include, but need not be limited to, operating systems, applications, obtained context data, and informational data. Each operating system includes executable code that controls basic functions of the device, such as interaction among the various components, communication with external devices via the wireless transceivers 602 and/or the component interface 614, and storage and retrieval of applications and context data to and from the local storage medium 606. Each application includes executable code that utilizes an operating system to provide more specific functionality for the communication devices, such as file system service and handling of protected and unprotected data stored in the local storage medium 606.

The local storage medium 606 stores various content including, but not limited to, an voice to text conversion application 624, and a NLU model 626 and EDC model 628. The voice to text conversion application 624 is provided for converting spoken words into text form utilizing context data provided by the primary electronic device 502 and the secondary electronic devices 504. The voice to text conversion application 624 includes program instructions accessible by the one or more processors 604 to direct a processor 604 to implement the methods, processes and operations described herein including, but not limited to the methods, processes and operations illustrated in the Figures and described in connection with the Figures. Additionally, the local storage medium/memory 606 stores context data 616, device identifiers, network electronic device addresses, control content and the like.

Among other things, the voice to text conversion application 624 manages operation of the processor 604 in connection with capturing context data from the primary electronic device 502 and secondary electronic devices 504. For example, the processor 404 may manage operation of a camera unit 430 in connection with collecting image data and/or may manage operation of the transceiver 602 in connection with collecting communications data. The voice to text conversion application 524 may further manage the processor 504 to analyze the image data utilizing image recognition software, analyze sounds from a microphone utilizing voice recognition software, etc.

Each transceiver 602 can utilize a known wireless technology for communication. Exemplary operation of the wireless transceivers 602 in conjunction with other components of the primary electronic device 502 may take a variety of forms and may include, for example, operation in which, upon reception of wireless signals, the components of primary electronic device 502 detect communication signals from secondary electronic devices 504 and the transceiver 602 demodulates the communication signals to recover incoming information, such as responses to inquiry requests, voice and/or data, transmitted by the wireless signals. The processor 504 formats outgoing information and conveys the outgoing information to one or more of the wireless transceivers 602 for modulation to communication signals. The wireless transceiver(s) 602 convey the modulated signals to a remote device, such as a cell tower or a remote server (not shown).

In accordance with the embodiments of FIG. 6, the processor 604 directs the transceiver 602 to transmit an inquiry request and listen for responses from secondary electronic devices 504. The processor 504 analyzes the portions of the response to obtain context data. The processor analyzes the context data to perform some or all of the remaining operations described in FIGS. 3-4 to convert spoken words into text form.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a data storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable data storage device, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. An electronic device comprising:
a processor;
a data storage device having executable instructions accessible by the processor;
wherein, responsive to execution of the instructions, the processor:
obtains primary context data related to a spoken word;
obtains secondary context data related to the spoken word from a secondary electronic device;
analyzes the primary context data and the secondary context data utilizing & an electronic device context (EDC) model to determine a context of the spoken word; and
converts the spoken word into a text form based on the context of the spoken word.

2. The electronic device of claim 1, wherein the operating step of analyzing the primary context data and the secondary context data utilizing the EDC model to determine the context of the spoken word comprises applying a natural language understanding (NLU) model.

3. The electronic device of claim 2, wherein the NLU model and EDC model separately, or in combination, determine the context of the spoken word.

4. The electronic device of claim 1, wherein the primary context data is obtained from the data storage device.

5. The electronic device of claim 1, further comprising at least one sensor; and wherein the primary context data is obtained from the at least one sensor.

6. The electronic device of claim 5, wherein the at least one sensor includes one of image recognition software, gesture recognition software, voice recognition software, or global positioning system (GPS) software.

7. The electronic device of claim 1, wherein the secondary electronic device is one of a smart phone, a smart watch, a smart TVs, a tablet device, a personal digital assistant (PDAs), a voice-controlled intelligent personal assistant service device, or a smart speaker.

8. A method, comprising:
under control of one or more processors including program instructions to:
obtain primary context data related to a spoken word from a primary electronic device;
obtain secondary context data related to the spoken word from a secondary electronic device;
analyze the primary context data and the secondary context data utilizing an electronic device context (EDC) model to determine a context of the spoken word; and
convert the spoken word into a text form based on the context of the spoken word.

9. The method of claim 8, wherein to analyze the primary context data and the secondary context data utilizing an electronic device context model to determine the context of the spoken word comprises applying a natural language understanding (NLU) model.

10. The method of claim 9, wherein the NLU model and EDC model separately, or in combination, determine the context of the spoken word.

11. The method of claim 8, wherein to obtain the primary context data includes accessing a data storage device of the primary electronic device.

12. The method of claim 8, wherein to obtain the primary context data includes detecting, with a sensor the primary context data.

13. The method of claim 8, wherein to obtain the secondary context data includes automatically wirelessly communicating the secondary context data from the secondary electronic device to the primary electronic device.

14. The method of claim 8, wherein the one or more processors further including program instructions to, obtain auxiliary secondary context data from an auxiliary secondary electronic device, and analyze the primary context data, the secondary context data, and auxiliary secondary context data utilizing the EDC model to determine the context of the spoken word.

15. The method of claim 8 wherein to convert the spoken word into a text form based on the context of the spoken word including determining, with the one or more processors, a candidate text form, and modifying the candidate text form to the text form based on the context of the spoken word determined.

16. The method of claim 15, wherein the candidate text form is determined by a natural language understanding model, and the candidate text form is modified by the EDC model.

17. A computer program product comprising a non-signal computer readable storage medium comprising computer executable code to convert a spoken word into text by automatically:
detecting a spoken word;
obtaining primary context data from a primary electronic device;
receiving, at the primary electronic device, secondary context data obtained by and communicated from one or more secondary electronic devices;
analyzing the primary context data and the secondary context data utilizing an electronic device context (EDC) model to determine a context of the spoken words; and
choosing between two or more candidate text forms based on the context of the spoken words determined when converting the spoken word into a text form.

18. The computer program product of claim 17, the computer executable code to utilize the electronic device context model to determine at least one of: a subject related to a program displayed by the secondary electronic device; a presence of two or more individuals; or a meeting or an event scheduled in a calendar of a secondary electronic device.

19. The computer program product of claim 17, the computer executable code to identify individuals in an environment, and utilize the identification of the individuals as one of the primary context data or the secondary context data.

20. The computer program product of claim 17, the computer executable code to modify a natural language understanding (NLU) model based on the context of the spoken word determined.
